(19) United States
(12) Patent Application Publication
(10) Pub. No.: US 2020/0256035 A1
(43) Pub. Date: Aug. 13, 2020

(54) CONFIGURABLE CONTROL INPUT FOR WORK MACHINE

(71) Applicant: Caterpillar Inc., Deerfield, IL (US)

(72) Inventor: Kevin M. Moloney, Washington, IL (US)

(73) Assignee: Caterpillar Inc., Deerfield, IL (US)

(21) Appl. No.: 16/274,900

(22) Filed: Feb. 13, 2019

(51) Int. Cl. E02F 9/20; E02F 3/76; G05G 1/06; G05G 9/047

(52) U.S. Cl. CPC E02F 9/2004; E02F 3/7645; G05G 1/06; G05G 2009/04774; E02F 9/2087; E02F 3/7663; G05G 9/04788

(57) ABSTRACT

A control system and method for a work machine includes an input control, an input interface, and a controller. The input control is moveable in at least a first direction to provide control of the work machine. The input interface is configured to receive a control selection input. The controller is configured to set a control action in response to receiving the control selection input from the input interface, and the work machine is controlled as defined by the control action upon the input control moving in the first direction to a position along the first direction.

### TECHNICAL FIELD

The present application relates generally to work machines. More particularly, the present application relates to configurable control for work machines.

### BACKGROUND

Work machines such as motor graders, for example, are used for a variety of tasks requiring operator control of the work machine and various implements associated with the machine. These work machines can be complex, requiring several control inputs to operate the vehicle. For example, an operator interface of the work machine can include numerous controls for steering, position, orientation, transmission gear ratio, and travel speed of the work machine, as well as position, orientation, depth, width, and angle of the work implement. It is desirable to provide controls that are both intuitive and flexible to provide optimal operator control.

U.S. Pat. No. 7,497,298 B2 to Caterpillar Inc., teaches a joystick control system that includes left and right joysticks positioned on each side of an operator. It is desirable to add further intuitiveness and control to the already existing controls for motor graders and other work machines.

### SUMMARY OF THE INVENTION

In one example, a control system for a work machine includes an input control, an input interface, and a controller. The input control is moveable in at least a first direction to provide control of the work machine. The input interface is configured to receive a control selection input. The controller is configured to set a control action in response to receiving the control selection input from the input interface, and the work machine is controlled as defined by the control action upon the input control moving in the first direction to a position along the first direction.

In another example, a method of controlling a work machine includes receiving a control selection input through an input interface of the work machine; setting, by a controller, a control action in response to receiving the control selection input; detecting movement of an input control in a first direction to or beyond a position along the first direction; and controlling the work machine as defined by the control action upon detection that the input control is at or beyond the position along the first direction.

In another example, a system for controlling a work machine includes a joystick, an input interface, and a controller. The joystick is moveable in a first direction to control the work machine. The input interface is configured to receive a control selection input that defines a control action for the work machine. The controller is configured to determine that the joystick has moved to or beyond a position in the first direction and in response to execute the control action.

### BRIEF DESCRIPTION OF THE DRAWING S

FIG. 1A is a side view illustrating a motor grader.

FIG. 1B is a top view illustrating a motor grader.

FIG. 2 is a block diagram illustrating a control system for a work machine.

FIG. 3A is a perspective view of an example joystick used for controlling a work machine.

FIG. 3B is a diagram illustrating example paths for a joystick used for controlling a work machine.

FIG. 4 is a flowchart illustrating a method of controlling a work machine using configurable controls for joystick positions.

### DETAILED DESCRIPTION

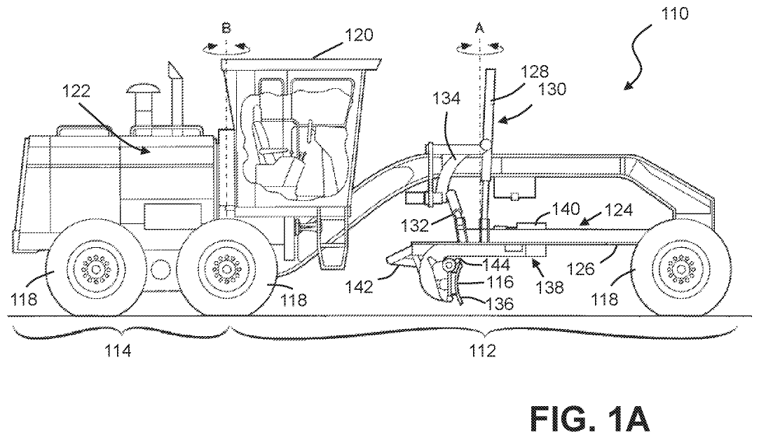

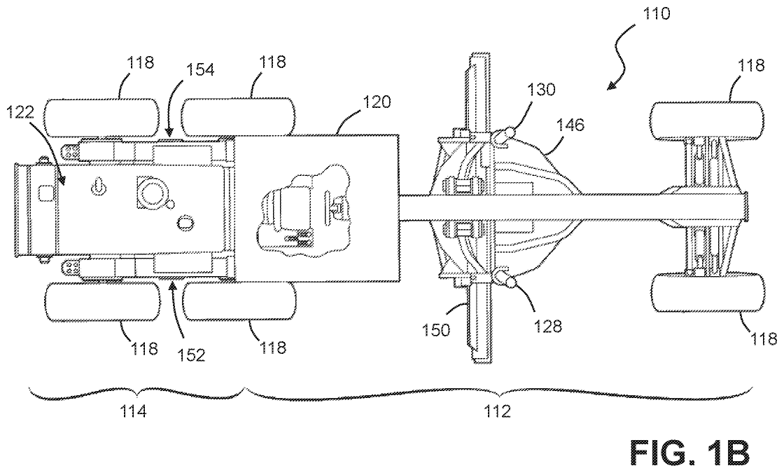

FIG. 1A is a side view illustrating a motor grader 110 and FIG. 1B is a top view illustrating the motor grader 110. While illustrated and described as a motor grader 110, the embodiments described herein can be used for any construction, industrial, or other light or heavy working machine. Examples according to this disclosure are also applicable to compactors, mixers, scrapers, dozers, excavators, material haulers, and other example machine types.

The motor grader 110 can be used primarily as a finishing tool, for example, to sculpt a surface of earth to a final arrangement. Rather than moving large quantities of earth in the direction of travel like other machines, such as a bulldozer, the motor grader 110 typically moves relatively small quantities of earth from side to side. In other words, the motor grader 110 typically moves earth across the area being graded, not straight ahead.

The motor grader 110 includes a front frame 112, a rear frame 114, and a blade 116. The front and rear frames 112 and 114 are supported by wheels 118. An operator cab 120 containing many controls necessary to operate the motor grader 110 is mounted on the front frame 112. An engine, shown generally at 122, is used to drive or power the motor grader 110. The engine 122 is mounted on the rear frame 114. The blade 116, sometimes referred. to as a moldboard, is used to move and grade earth or other aggregate materials. The blade 116 is mounted on a linkage assembly, shown generally at 124. The linkage assembly 124 allows the blade 116 to be moved to a variety of different positions relative to the motor grader 110. Starting at the front of the motor grader 110 and working rearward toward the blade 116, the linkage assembly 124 includes a drawbar 126.

The drawbar 126 is mounted to the front frame 112 with a ball joint, for example. The position of the drawbar 126 is controlled by three hydraulic cylinders, commonly referred to as a right lift cylinder 128, a left lift cylinder 130, and a center shift cylinder 132. A coupling, shown generally at 134, connects the three cylinders 128, 130, and 132 to the front frame 112. The coupling 134 can be moved during blade repositioning but is fixed stationary during earthmoving operations. The height of the blade 116 with respect to the surface of earth below the motor grader 110, commonly referred to as blade height, is controlled primarily with the right and left lift cylinders 128 and 130. The right and left lift cylinders 128 and 130 can be controlled independently and, thus, used to angle a bottom cutting edge 136 of the blade 116 relative to the surface of earth. The center shift cylinder 132 is used primarily to sideshift the drawbar 126, and all the components mounted to the end of the drawbar 126, relative to the front frame 112. This sideshift is commonly referred to as drawbar sideshift or circle centershift.

The drawbar 126 includes a large, flat plate, commonly referred to as a yoke plate 146. Beneath the yoke plate 146 is a large gear, commonly referred to as a circle 138. The circle 138 is rotated by a hydraulic motor, commonly referred to as a circle drive 140. The rotation of the circle 138 by the circle drive 140, commonly referred to as circle rotation or blade rotation, pivots the blade 116 about a generally vertical axis A perpendicular to the drawbar 126 to establish a blade cutting angle. The blade cutting angle is defined as the angle of the blade 116 relative to the front frame 112. At a zero degree blade cutting angle, the blade 116 is aligned at a right angle to the drawbar 126.

The blade 116 is mounted to a hinge on the circle 138 with a bracket. A blade tip cylinder 142 is used to pitch the bracket forward or rearward. In other words, the blade tip cylinder 142 is used to tip a top edge 144 of the blade 116 ahead of or behind the bottom cutting edge 136 of the blade 116. The position of the top edge 144 of the blade 116 relative to the bottom cutting edge 136 of the blade 116 is commonly referred to as blade tip or blade pitch. This allows height adjustment of both sides of the blade 116 at once, and also allows a secondary vertical height adjustment of the cutting edge 136, with finer resolution than the lift cylinders.

The blade 116 is mounted to a sliding joint in the bracket allowing the blade 116 to be slid or shifted from side to side relative to the bracket or the circle 138. This side to side shift is commonly referred to as blade side shift. A side shift cylinder 150 is used to control the blade sideshift. A right articulation cylinder 152 is mounted to the right side of the rear frame 114 and a left articulation cylinder 154 is mounted to the left side of the rear frame 114. The right and left articulation cylinders 152 and 154 are used to rotate the front frame 112 about a vertical axis B. The axis B is commonly referred to as the articulation axis.

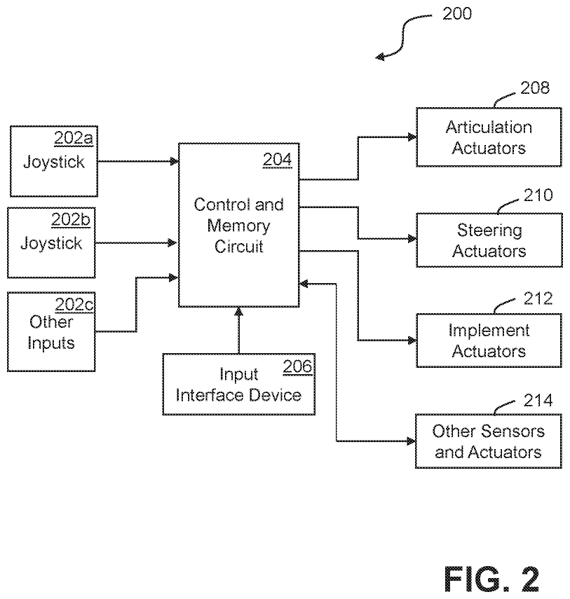

FIG. 2 is a block diagram illustrating a control system 200 for a work machine, such as motor grader 110. The control system 200 includes joysticks 202a and 202b, other control inputs 202c, control and memory circuit 204, input interface device 206, articulation actuators 208, steering actuators 210, implement actuators 212, and other sensors and actuators 214.

The joysticks 202a and 202b can be used by an operator of the motor grader 110 to control the motor grader 110. In an example, the joysticks 202a and 202b can be located in an operator station of the motor grader 110 and positioned on each side of an operator seat. The work machine can include other control inputs 202c which can be any other input controls including levers, buttons, switches, and/or touch screens that can be used in place of, or in addition to, the joysticks 202a and 202b to control the motor grader 110,

The control and memory circuit 204 can include, for example, software, hardware, and combinations of hardware and software configured to execute several functions related to control of the motor grader 110. The control and memory circuit 204 can be an analog, digital, or combination analog and digital controller including a number of components. As examples, the control and memory circuit 204 can include integrated circuit boards or ICB(s), printed circuit boards PCB(s), processor(s), data storage devices, switches, relays, or any other components. Examples of processors can include any one or more of a. microprocessor, a controller, a digital signal processor (DSP), an application specific integrated circuit (ASIC), a field-programmable gate array (FPGA), or equivalent discrete or integrated logic circuitry.

The control and memory circuit 204 may include storage media to store and/or retrieve data or other information such as, for example, input data from the input interface device 206. Storage devices, in some examples, are described as a computer-readable storage medium, The data storage devices can be used to store program instructions for execution by processor(s) of control and memory circuit 204, for example. The storage devices, for example, are used by software, applications, algorithms, as examples, running on and/or executed by control and memory circuit 204. The storage devices can include short-term and/or long-term memory and can be volatile and/or non-volatile. Examples of non-volatile storage elements include magnetic hard discs, optical discs, floppy discs, flash memories, or forms of electrically programmable memories (EPROM) or electrically erasable and programmable (EEPROM) memories. Examples of volatile memories include random access memories (RAM), dynamic random access memories (DRAM), static random access memories (SRAM), and other forms of volatile memories known in the art.

The input interface device 206 is any interface device capable of receiving input from an operator or other user of the motor grader 110. For example, the input interface device 206 can be a keyboard, keypad, touchscreen, dial(s), switch(es), or any other input device capable of converting a user input into one or more signals interpretable by the control and memory circuit 204. In an example, the input interface device 206 is a touchscreen display.

The control and memory circuit 204 provides outputs to control the motor grader 110. Control can be accomplished through provision of control signals for articulation actuators 208, steering actuators 210, implement actuators 212, and other sensors and actuators 214. For example, the articulation actuators 208 can be controlled to articulate the motor grader about the axis B (FIG. 1), the steering actuators 210 can be controlled to turn the front wheels 118 (FIG. 1), and the implement actuators can be controlled to adjust the position and orientation of the blade 116 (FIG. 1) or other attached auxiliary implements. The control and memory circuit 204 can also receive input from, and provide output to, other sensors and actuators 214. For example, sensors can provide position, temperature, grade, or any other desired values for control and monitoring of the motor grader 110.

Some of the controls for the motor grader 110 can be programmable through the input interface device 206. For example, the input interface device 206 can be a touchscreen display configured to output various menus and other displays for an operator. The operator may he able to program one or more control aspects through a settings menu displayed on the touchscreen device, for example. In one example, an operator can program a desired control action to be initiated upon one of the joysticks 202a or 202b reaching a trigger position.

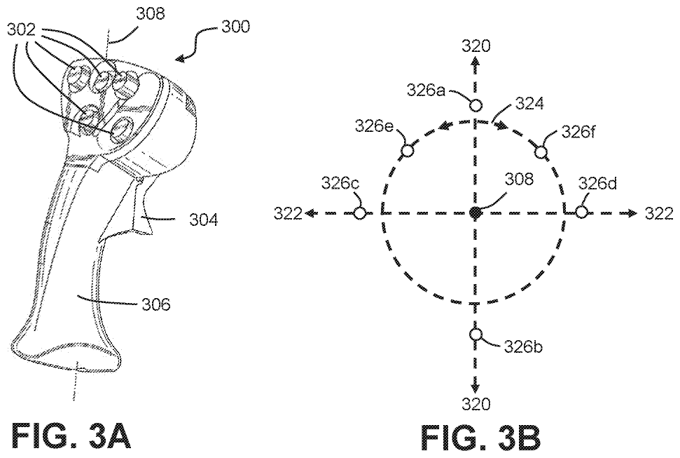

FIG. 3A is a perspective view of an example joystick 300 used for controlling a work machine. FIG. 3B is a diagram illustrating example paths for the joystick 300 used for controlling a work machine. The example joystick 300 can be used as either of joysticks 202a or 202b of FIG. 2. The joystick 300 can include buttons 302 and a trigger 304 disposed on a lever 306. Various functions of the motor grader 10 may be actuated in different manners according to the condition and/or position of the buttons 302, the position of the trigger 304, and the position and orientation of the lever 306.

In one example, the joystick 300 can be used as the joystick 202a and be located to the left of an operator as seated. In the left joystick example, some operations that can be controlled by the buttons 302 include causing the transmission output speed ratio to change, causing the transmission to shift to a higher output speed ratio, causing the transmission to shift to a lower output speed ratio, causing the wheels 118 to lean or tilt relative to a tilt plane through horizontal axis, causing the wheels 118 to tilt to the left relative to an operator's perspective, causing the wheels 118 to tilt to the right. The tilt speed of the Wheels 118 can correspond to the engagement positions of one or more of the buttons 302. One of the buttons 302 can be a. neutral articulation button, for example, configured to move the motor grader 110 back to a neutral alignment (zero degrees articulation) after an articulated operation.

Also in the left joystick example, the trigger 304 can be configured to control a transmission condition when actuated, for example. Trigger 304 can be a three-way rocker switch, for example, that toggles between a forward, neutral, and reverse output direction of the transmission. As seen in FIG. 3B, twisting lever 306 about a. longitudinal axis 308 may cause the motor grader 110 to articulate. A twist of the lever 306 in a clockwise manner may cause a forward portion of the motor grader 110 to articulate in a clockwise direction about the articulation axis B (FIG. 1).

Tilting the lever 306 along axis 320 may cause the blade 116 to move in a generally vertical direction. For example, tilting the lever 306 forward may cause a left end (relative to an operator's perspective) of the blade 116 to lower, while tilting the lever 306 rearward may cause a left end of the blade 116 to lift. The magnitude of the lever tilt angle away from axis 308 in the fore/aft direction, along the axis 320, may relate to a speed of blade movement. Tilting the lever 306 side-to-side away from the longitudinal axis 320 along the axis 322, may cause the angle of one or more of the wheels 118 to rotate to steer the motor grader 110. The magnitude of the lever tilt angle away from the axis 308, along the axis 322 in the side-to-side direction may be related to the rotation angle of the wheels 118.

In another example, the joystick 300 can be used as the joystick 202b and located to the right of the operator while seated. In the right joystick example, the joystick 300 can include a four-way rocker switch in addition to, or in place of, the buttons 302. One or more buttons 302 can also be located in other positions on the joystick 300. The rocker switch can be disposed on the lever 306, for example. Various functions of the motor grader 110 can be actuated in different manners according to an engagement position of the rocker switch, the position of the trigger 304, and the orientation of the lever 306.

Also in the right joystick example, the trigger 304 may be configured to control an engine speed control feature when actuated. Twisting the lever 306 about the vertical axis through 308 may cause the right side of the blade 116 to rotate about the axis A (FIG. 1). Tilting the lever 306 side-to-side along axis 322 may cause the blade 116 to shift in the same direction as the tilt of the lever 306. Tilting the lever 118 in a fore/aft direction along axis 320 may cause the blade 116 to move in a vertical direction, as viewed from an operator's perspective.

FIG. 3B also illustrates example positions 326a-326f along axial paths 320 and 322, and rotational path 324 of a joystick 300. Detents can be placed at any of the positions 326a-326f, or any other desirable positions along any of the movement directions of the joystick 300 in either the right or the left joystick examples. A detent can be utilized at one of the positions 326a-326f to provide tactile feedback, for example, to an operator to inform the operator that the joystick has reached or passed the respective position. In other examples, detents can be used to hold the joystick in the position of the respective detent. The joystick 300 moving to any one of the positions 326a-326f can also be detected using one or more sensors, for example, without the use of a detent. In this example, the joystick 300 is not held in position when reaching the respective position 326a-326f.

The motor grader 110 can be controlled in a desired manner upon the joystick 300 reaching any one of the positions 326a-326f or any other desired position. How the motor grader 110 is controlled can be programmed based on user input. For example, an operator can modify the operation of some of the default control functions (e.g., a fine/normal/coarse map selection for a given joystick movement), turn on/off automated functions that can be used to trigger a function related to the individual joystick movement (for example, an articulation twist detent to trigger return to center, rather than using a separate button for return to center), or select/combine multiple functions to be driven by a single input (for example, linking articulation and/or wheel lean to an existing steering joystick function).

In one example, a detent can be placed at position 326f on the left joystick. Movement of the respective joystick clockwise in the rotational direction 324 toward the position 326f may control articulation of the motor grader 110, for example. Movement of the respective joystick to or past position 326f can automatically articulate the motor grader 110 to a desired angle. This angle can be programmable by an operator of the motor grader 110 through the input control interface 206, for example.

By using a detent and a programmable angle, the motor grader can be articulated to a desired angle without requiring the operator to twist and hold the joystick until the motor grader 110 reaches the desired articulation angle. This provides improved ergonomics for the operator while also simplifying the control of the motor grader 110. The angle can be programmable based on the work site, for example. In an example, other positions 326a-326e with or without detents can be used in addition to the detent at position 326f. For example, twisting the joystick to the position 326e can control the motor grader to articulate in the opposite direction to a desired, programmable, angle.

A detent or detected position can also be used to initiate multiple controls for the motor grader 110. For example, twisting the joystick to one of the positions 326e or 326f can initiate control of multiple functions. In one example, reaching a specified position can initiate control of circle motion of the blade 116, articulation of the motor grader 110, and wheel lean of the wheels 118. The amount of circle motion, articulation, and wheel lean can be specified by an operator through the input interface device 206, for example.

Custom control settings programmed through the input interface device 206, for example, can be used to set up worksite specific controls to provide easier control of the motor grader 110 for an operator. In one example, control of a joystick to one of the positions 326a-326f can be used to achieve a “mirror” function. For example, the operator can program one of the joystick positions 326a-326f through the input interface device 206 to perform a mirror function that produces a mirror image of the current settings for the blade 116. Mirroring functions can also provide a mirror image for the articulation of the machine 110 and/or wheel lean of the wheels 118. This is especially advantageous for worksites in which an operator will be making many passes back and forth over a work area and would otherwise need to make multiple manual adjustments to mirrored positions for several different implement functions for each pass.

### INDUSTRIAL APPLICABILITY

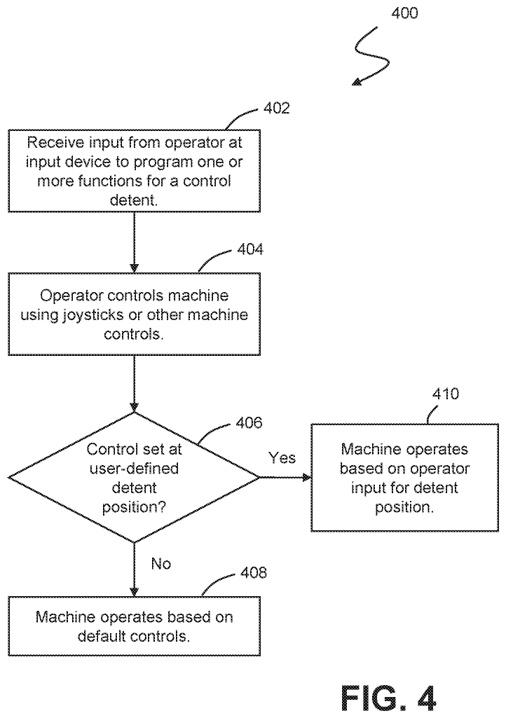

In one illustrative example, a motor grader is controlled by an operator using at least one programmable control input. As seen in FIG. 4, at step 402, the operator enters a selectable control input through a user interface of the motor grader. The user interface can be a touchscreen, for example. The operator selects which position on which control (e.g., joystick) triggers the control action. In one example, the operator sets a control action for a detail in the clockwise rotational direction of a lever of a right control joystick. The clockwise rotational direction of the right control joystick may normally control clockwise circle rotation motion of a blade of the motor grader, for example. The other controls may be set up to be equally intuitive. The operator may program the controls such that once the lever of the right joystick is twisted clockwise beyond a reference position, the motor grader is controlled such that the blade moves to a specified rotational position, the motor grader articulates to a specified angle, and the wheels lean a specified amount.

At step 404, the operator controls the motor grader using the operation controls found in an operator station of the motor grader, for example. This can include left and right joysticks, as well as other buttons, switches, and inputs available in the operator station. The method 400 monitors for movement of the control to or past the reference position during step 406. If the operator has not moved the control to or past the reference position, the method 400 proceeds to step 408 and controls the motor grader using the default controls. If the operator has moved the control to or past the reference condition, the method 400 proceeds to step 410 and controls the motor grader using the user specified control. By providing control selection through the input interface, control flexibility and efficiency is increased.

The above detailed description is intended to be illustrative, and not restrictive. The scope of the disclosure should, therefore, be determined with references to the appended claims, along with the full scope of equivalents to which such claims are entitled.

What is claimed is:

1. A control system for a work machine, the control system comprising:
a first input control moveable in at least a first direction to provide control of the work machine:
an input interface configured to receive a control selection input; and
a controller configured to set a first control action in response to receiving the control selection input from the input interface;
wherein the work machine is controlled as defined by the first control action upon the first input control moving in the first direction to a first position along the first direction.

2. The control system of claim 1, wherein a first detent is positioned at the first position along the first direction.

3. The control system of claim 2, wherein the first direction is an axial direction, and wherein the first input control is configured to move in a second direction different than the first direction, and wherein a second detent is positioned for the first input control along the second direction.

4. The control system of claim 3, wherein the first input control is a joystick, and wherein the joystick is configured to rotate about an axis, and wherein a third detent is positioned for the first input control in the rotational direction

5. The control system of claim 1, further comprising:
a second input control moveable in at least a second direction to provide control of the work machine;
wherein the controller is further configured to set a second control action in response to receiving the control selection input through the input interface; and
wherein the work machine is controlled as defined by the second control action upon the second input control moving in the second direction to a second position along the second direction.

6. The control system of claim 5, wherein the work machine is a motor grader, and wherein the first input control and the second input control are joysticks each configured to move in two axial directions and rotationally to provide control for the motor grader.

7. The control system of claim 6, wherein the motor grader is an articulated vehicle that includes a blade that can move in a circular motion, wherein the first control action is a combination of a specified circle motion of the blade, an articulation of the motor grader, and a wheel lean of wheels of the motor grader.

8. A method of controlling a work machine, the method comprising:
receiving a control selection input through an input interface of the work machine;
setting, by a controller, a first control action in response to receiving the control selection input;
detecting movement of a first input control in a first direction to or beyond a first position along the first direction; and
controlling the work machine as defined by the first control action upon detection that the first input control is at or beyond the first position along the first direction.

9. The method of claim 8, wherein detecting movement of a first input control in a first direction to or beyond a first position along the first direction comprises detecting that the first input control has moved to or beyond a first detent positioned at the first position and configured to hold the first input control at the first position.

10. The method of claim 9, further comprising:
detecting movement of the first input control in a. second direction to or beyond a second detent located at a second position along the second direction.

11. The method of claim 10, wherein the first input control is a joystick, and wherein detecting movement of the first input control in the first direction comprises detection rotational movement of the joystick.

12. The method of claim 8, further comprising:
setting, by the controller, a second control action in response to receiving the control selection input;
detecting movement of a second input control in a second direction to or beyond a second position along the second direction; and
controlling the work machine as defined by the second control action upon detection that the second input control is at or beyond the second position.

13. The method of claim 12, wherein the work machine is a motor grader, and wherein the first input control and the second input control are joysticks each configured to move in two axial directions and rotationally to provide control for the motor grader.

14. The method of claim 13, wherein the motor grader is an articulated vehicle that includes a blade that can move in a circular motion, and wherein controlling the work machine as defined by the first control action upon detection that the first input control is at or beyond the first position along the first direction comprises controlling the motor grader to a specified circle motion of the blade, an articulation of the motor grader, and a wheel lean of wheels of the motor grader.

15. A system for controlling a work machine, the system comprising:
a first joystick moveable in a first direction to control the work machine;
an input interface configured to receive a control selection input that defines a control action for the work machine; and
a controller configured to determine that the first joystick has moved to or beyond a first position in the first direction and in response to execute the control action.

16. The system of claim 15, wherein a first detent is positioned at the first position.

17. The system of claim 16, wherein the first direction is a rotational direction, and wherein the first joystick is configured to move in first and second axial directions to further control the work machine.

18. The system of claim 15, further comprising:
a second joystick moveable in at least a second direction to provide control of the work machine;
wherein the controller is further configured to set a second control action in response to receiving the control selection input through the input interface; and
wherein the work machine is controlled as defined by the second control action upon the second input control moving in the second direction to a second position along the second direction.

19. The system of claim 18, wherein the work machine is a motor grader, and wherein the motor grader is an articulated vehicle that includes a blade that can move in a circular motion, and wherein the first control action is a combination of a specified circle motion of the blade, an articulation of the motor grader, and a wheel lean of wheels of the motor grader.

20. The system of claim 18, wherein the work machine is a motor grader, and wherein the motor grader is an articulated vehicle that includes a blade that can move in a circular motion, and wherein the first control action is a mirroring function that controls the blade to a mirrored position.
